(19) United States
(12) Patent Application Publication
(10) Pub. No.: US 2002/0033976 A1
(43) Pub. Date: Mar. 21, 2002

(54) Method and device for switching wavelength division multiplexed optical signals using gratings

(76) Inventor: Richard B. Holmes, Cameron Park, CA (US)

Correspondence Address: Ian F. Burns, P.O. Box 20038, Reno, NV, 89515-0038, US

(21) Appl. No.: 09/812,306

(22) Filed: Mar. 19, 2001

Related U.S. Application Data
(63) Continuation-in-part of application No. 09/666,898, filed on Sep. 20, 2000.

(51) Int. Cl. H04J 14/02

(52) U.S. Cl. 359/124; 359/128; 359/130

(57) ABSTRACT

A switch device and method is disclosed that is capable of switching wavelength division multiplexed optical signals. The optical switch device includes sources, targets, switching elements, and gratings. The source transmits an optical signal and the targets receive the optical signal. Each switch element includes a detector array, an emitter array, and a switch controller. The detector receives light from the source. The emitter array has emitters that transmit light to the targets. The switch controller is in communication with the detector and the emitter array. The switch controller causes the emitter array to generate the detected signal. A grating is positioned between the source and the switch elements. The grating disperses the optical signal into sets of wavelengths. The switch elements are positioned to receive differing sets of wavelengths and to transmit sets of wavelengths in an imaging configuration with the sources or targets.

### CROSS REFERENCE TO RELATED APPLICATIONS

This application is a continuation-in-part application of U.S. patent application Ser. No. 09/666,898, filed on Sep. 20, 2000, having the same inventor and is herein incorporated by reference in entirety.

### BACKGROUND OF THE INVENTION

1. Field of Invention

The present invention relates to a device and method for switching wavelength division multiplexed light signals using gratings among optical fibers or other transmission media.

2. Description of Related Art

Optical communication systems are a substantial and rapidly growing part of communication networks. The expression “optical communication system,” as used herein, relates to any system that uses optical signals to convey information across an optical transmission device, such as an optical fiber. Such optical systems may include, but are not limited to telecommunication systems, cable television systems, and local area networks (LANs). While the need to carry greater amounts of data on optical communication systems has increased, the capacity of existing transmission devices is limited. Although capacity may be expanded, e.g., by laying more fiber optic cables, the cost of such expansion is prohibitive. Consequently, there exists a need for a cost-effective way to increase the capacity of existing optical transmission devices.

Wavelength division multiplexing (WDM) has been adopted as a means to increase the capacity of existing optical communication systems. In a WDM system, plural optical signals are carried over a single transmission device, each channel being assigned a particular wavelength.

An essential part of optical communication systems is the ability to switch or route signals from one transmission device to another. Micro-electromechanical mirrors have been considered for switching optical signals. However, this approach is not suitable for use with systems that use wavelength division multiplexed signals because micro-electromechanical mirrors cannot switch between signals of different wavelengths. Another approach utilizes bubbles that are capable of changing their internal reflection. However, this technique is also unable to switch multiple wavelengths individually. Furthermore, both of these devices have limited switching speeds, in the range of 10 kHz for the mirror devices and in the range of 100 Hz for the bubble devices.

Other switching approaches, such as the approach disclosed in U.S. Pat. No. 4,769,820, issued to Holmes, can switch data at GHz rates, which is effectively switching at GHz transition rates. However, this approach requires substantial optical switching power, has potential cross talk, and cannot resolve wavelength over-utilization issues.

Another switching approach is shown in U.S. Pat. No. 6,097,859, issued to Solgaard. This approach discloses a multi-wavelength cross-connect switch that uses multiple gratings. However, this approach requires separate input and output fiber paths increasing the number of components and cost as well as needing multiple lenses.

Yet another switching approach is shown in U.S. Pat. No. 6,181,853, issued to Wade. This approach discloses a Wavelength division multiplexing/demultiplexing device using dual polymer lenses. This approach suffers from not allowing spatial switching and does not allow imaging of multiple optical fibers carrying multiple wavelengths onto multiple targets.

In some instances, it is desired to switch between relatively few optical transmission devices with different wavelengths. In this situation, the prior art devices have been high in cost in relation to the bandwidth that is switched.

What is needed is a means for switching wavelength division multiplexed signals that is capable of doing so at high speeds with no cross talk, requires low switching power and can be accomplished at a low cost.

### SUMMARY OF INVENTION

1. Advantages of the Invention

One advantage of the present invention is that it is able to switch signals of different wavelengths.

Another advantage of the present invention is that it is able to switch signals at high speeds.

A further advantage of the present invention is that it does not require high power.

Another advantage of the present invention is that it does not suffer from crosstalk.

Another advantage of the present invention is that it is able to switch between wavelengths and fibers to avoid transmission device or wavelength over-utilization.

Another advantage of the present invention is that it is able to broadcast to multiple transmission devices or couplers simultaneously.

A further advantage of the present invention is that it is able to regenerate and restore signals.

An additional advantage of the present invention is that it can transmit through air or other intervening media to a receiver without a costly or slow electrical interface.

Another advantage of the present invention is that it can switch multiple wavelength signals between relatively few optical transmission devices at low cost.

These and other advantages of the present invention may be realized by reference to the remaining portions of the specification, claims, and abstract.

2. Brief Description of the Invention

The present invention comprises an optical switch device. The optical switch device comprises at least one source, at least one target, at least a first and second switch element, and a grating. The source is adapted to transmit an optical signal and the targets are adapted to receive the optical signal. Each switch element comprises a detector, an emitter array, and a switch controller. The detector is positioned to receive light from the source. The detector is adapted to detect optical signals. The emitter array is positioned to transmit light to the targets. The emitter array comprises a plurality of emitters. Each emitter is adapted to generate light signals. The light signals generated by each emitter is transmitted to at least one of the targets. The switch controller is in communication with the detector and the emitter array. The switch controller is adapted to cause the emitter array to generate the detected signal. A grating is positioned between the source and the switch elements. The grating is adapted to disperse the optical signal into at least a first and second set of wavelengths. The first switch element is positioned to receive the first set of wavelengths and to transmit optical signals to the target. The second switch element is positioned to receive the second set of wavelengths and to transmit optical signals to the target.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a side schematic diagram of the preferred embodiment of the optical switch device using gratings of the present invention.

FIG. 2 is substantially an enlarged partial view of FIG. 1.

FIG. 3 is substantially a side schematic diagram of an alternative embodiment of the optical switch device using gratings of the present invention.

FIG. 4 is substantially a side schematic diagram of another embodiment of the optical switch device using gratings of the present invention.

FIG. 5 is substantially a schematic diagram of the switch element of the present invention.

FIG. 6 is substantially a schematic diagram of the switch element of the preferred embodiment of the present invention.

### DESCRIPTION OF THE PREFERRED EMBODIMENT

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made with out departing from the scope of the present invention.

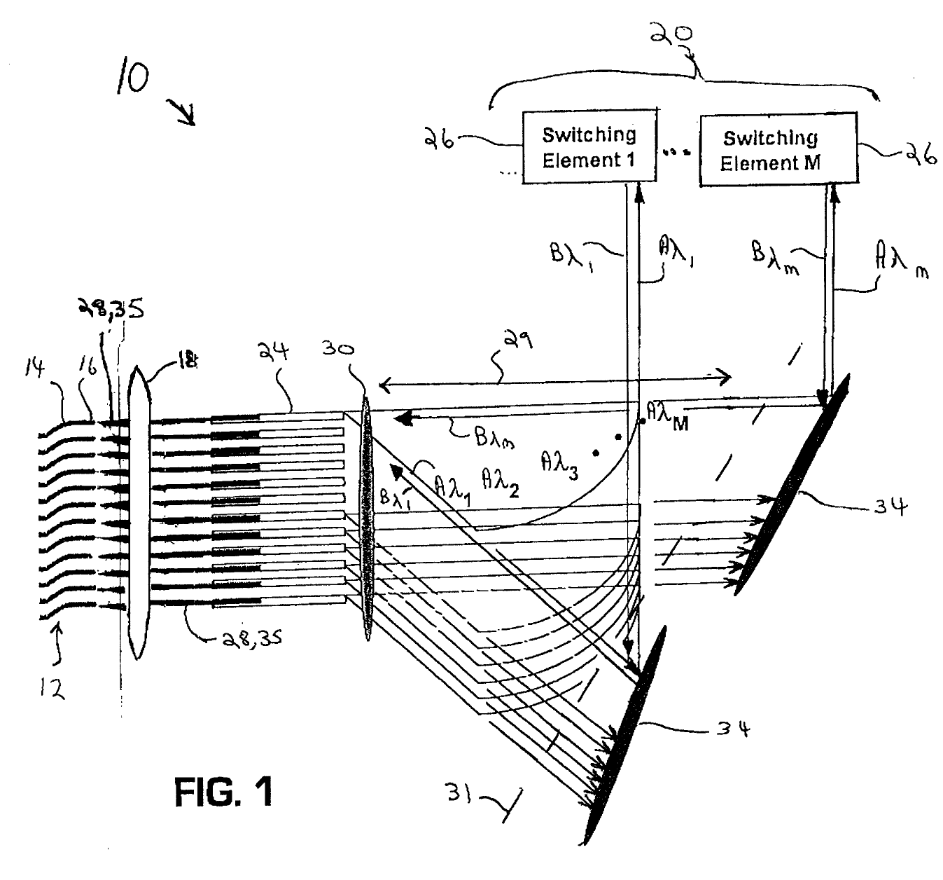

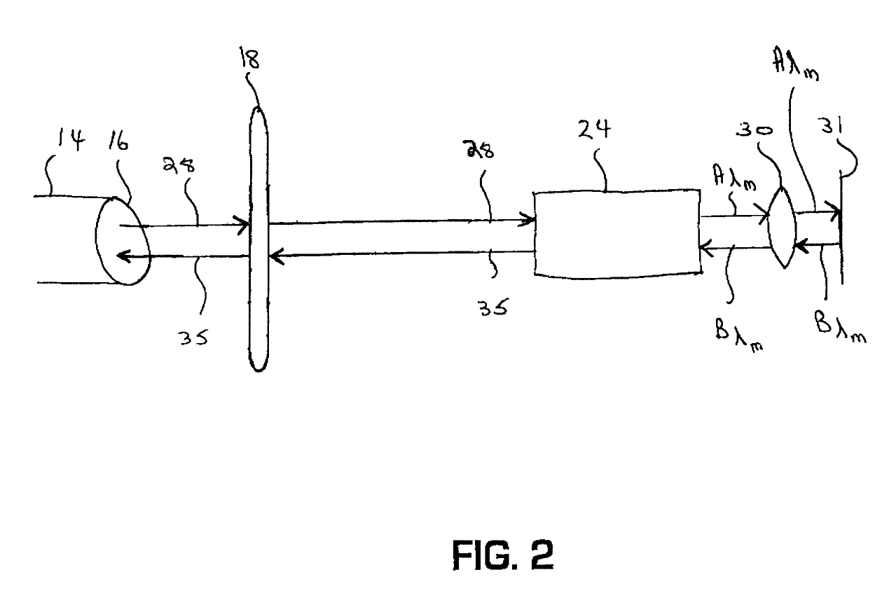

Referring to FIGS. 1 and 2, the present invention comprises a switch device generally indicated by reference number 10. Switch device 10 may be used in almost any optical communication system. Switch device 10 comprises sources and targets 12 and an array of switching elements 20 (not shown in FIG. 2). Sources and targets 12 are configured to transmit incoming signals and receive outgoing signals. Sources and targets 12 may be the same or different devices or objects. In the example shown in FIG. 1, sources and targets 12 are optical fibers 14, however, many other devices and transmission mediums may be used. Sources and targets 12 may include any number of fibers 14 and may use many different types of fibers. Each optical fiber 14 comprises an end 16. Ends 16 are preferably arranged in an array, wherein the ends are substantially planar. It is recognized that optical fibers 14 may have many different configurations, such as the linear array shown in FIG. 1 or a rectangular array.

The optical fibers 14 transmit an incoming optical signal 28 and receive an outgoing optical signal 35. Optical signal 28 exit end 16 and diverges until it reaches a desired diameter. In the preferred embodiment, the diameter is about 1 centimeter. This size is determined by the characteristics of a grating 24. A collimating lens 18 is positioned adjacent to each end 16 to ensure that the optical signals emerging from lens 18 are approximately a plane wave, to within a fraction of a wave. Collimating lens 18 may be similar to LAI011, available from Melles Griot, having an office in Irvine Calif.

After passing through lens 18, each incoming optical signal 28 impinges on grating 24. The grating 24 disperses or diffracts the incoming optical signals 28 to any number of bands, sets, or ranges of wavelengths; Aλ1, Aλ2, Aλ3 up to Aλm. Grating 24 may be similar to the-660 series grating with 3 centimeter width and 1.6 microns per line pair, available from ThermoRGL.

Grating 24 is preferably a reflective grating. However, a Bragg grating may also be used. The Bragg grating would be used when more wavelength selectivity is desired or to eliminate multiple orders of reflection. The Bragg grating would also be used when lenses are difficult to package. The dispersive power of a grating is a measure of the grating's ability to separate incoming light into component wavelengths. The dispersive power of a grating is given by dθ/dλ, which is equal to 1/(d_{g} cosθ), where θ, is the exiting angle, λ is the wavelength, and d_{g} is the grating period. In this example, the grating period is approximately 6 microns, and the exiting angle is 45 degrees. The resulting dispersive power of the grating is therefore equal to 0.236 radians per micron. The total angular displacement for the overall wavelength band of interest, which in this example, ranges from 1300 to 1560 nanometers (nm), is 0.0613 radians. The angular separation of two bands separated by 0.8 nm, for example, is 0.188 milliradians (mrad) for the dispersive power computed above. The full width of the diffracted light for a grating of total width w along the grating direction is approximately V/w, which for a 1 cm grating is about 0.15 mrad for wavelengths in the band of interest. It is recognized that other devices, such as a prism may, be used in place of grating 24.

After the incoming optical signal 28 is dispersed into different wavelengths Aλ1-Aλm, the signal is incident onto a first imaging lens 30 that is positioned to receive the optical signal from grating 24. Imaging lens 30 images the light transmitted by grating 24. Imaging lens 30 may be similar to LAI011, available from Melles Griot, similar to the collimating lens above. The wavelengths Aλ1-Aλm travel along an optical path 29 to an optical imaging plane 31. The distance from the imaging lens 30 and the optical imaging plane 31 is chosen such that the separation of wavelengths is equal to a few millimeters. Lens 30 is relatively achromatic. In this way, grating 24 separates wavelength division multiplexed light signals into individual signals.

At the optical image plane 31 conjugate to the source plane, mirrors 34 are located for each wavelength Aλ1-Aλm. Each mirror 34 directs the respective wavelengths to a switch element 26. Mirrors 34 may be similar to any small mirror available from numerous vendors, such as Newport or Melles-Griot. In the preferred embodiment, switching elements 26 are arranged in an arc to receive wavelengths Aλ1-Aλm. Mirrors 34 are placed between the refracted sets of wavelengths Aλm and Bλm. Mirrors 34 reflect the incoming sets of wavelengths Aλm toward switching elements 26. Mirrors 34 also reflect the outgoing sets of wavelengths Bλm toward imaging lens 30 along the same path as the incoming wavelengths. Mirrors 34 are used to further separate ranges of wavelengths. Additional imaging lenses (not shown) may be used inside switching elements 26 to manipulate signals received by each switching element.

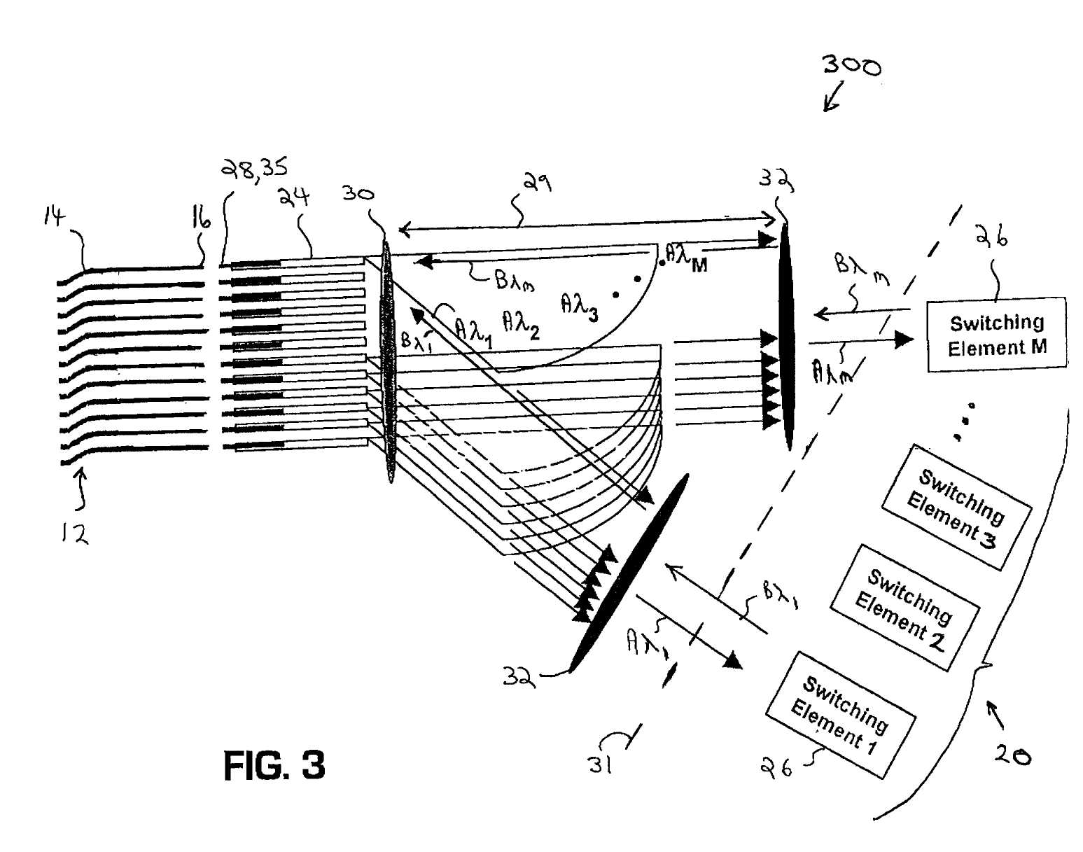

FIG. 3 illustrates an alternative embodiment of the optical switch device of the present invention. Optical switch device 300 is similar to optical switch device 10, except that mirrors 34 are replaced by imaging lenses 32 and the collimating lens 18 is omitted. After the incoming optical signal 28 is dispersed into different wavelengths Aλ1-Aλm, the of wavelengths are incident onto a first imaging lens 30 that is adjacent to grating 24. Imaging lens 30 images the different wavelengths Aλ1-Aλm along an arc. Imaging lens 30 may be similar to LAI011, available from Melles Griot, similar to the collimating lens above. The wavelengths Aλ1-Aλm travel along an optical path 29 to an optical imaging plane 31. The distance from the imaging lens 30 and the optical imaging plane 31 is chosen such that the separation of wavelengths is equal to a few millimeters. The imaging preferably uses a lens 30 that is relatively achromatic. In this way, grating 24 separates wavelength division multiplexed light signals into individual signals. At the optical image plane 31, the imaging lens 32 directs the respective wavelength to a switch element 26.

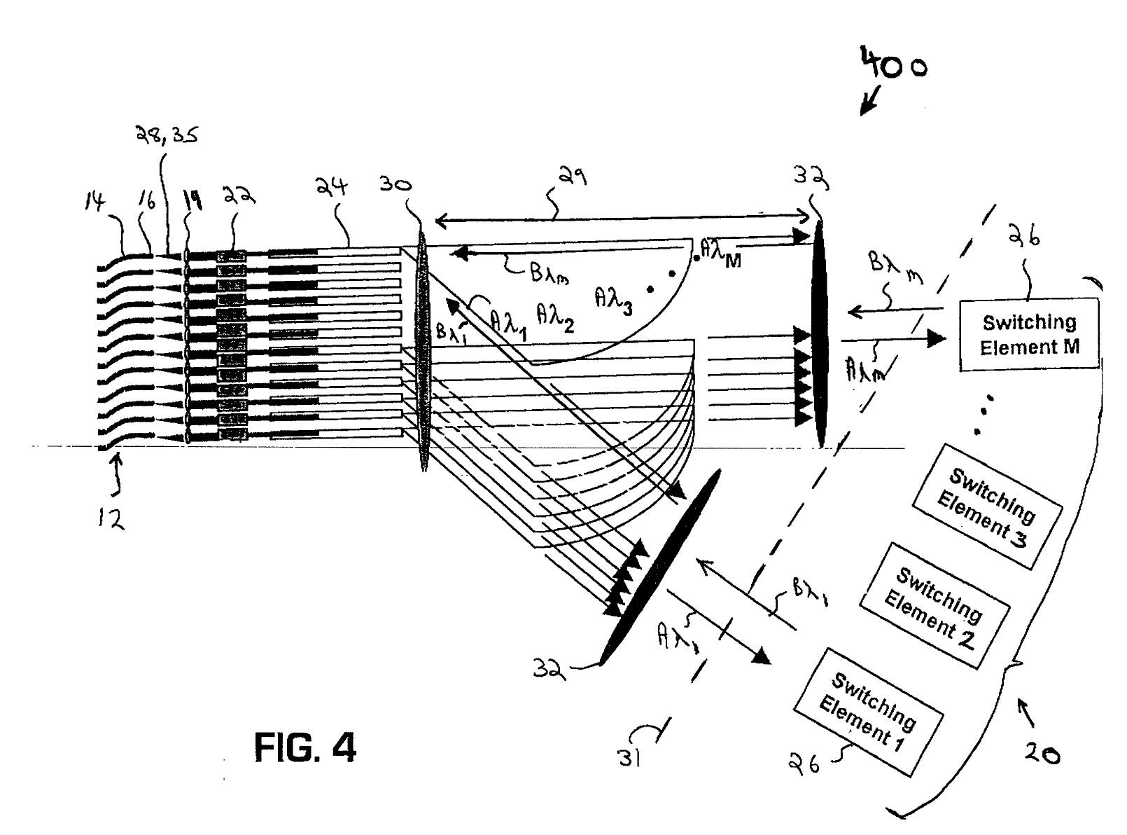

FIG. 4 illustrates another embodiment of the present invention in which an optical switch 400 is similar to optical switch device 300, except for the addition of collimating lenslets 19 and beam former 22. The spatial shape of the optical signals 28 may be shaped using a beam former or expander 22. Beam former 22 may comprise a cylindrical lens or mirror pair that is available as model 01 LCN002 and 01 LCP011 from Melles Griot. Beam former 22 is positioned adjacent to collimating lenslets 19. The shaping is performed to avoid clipping and loss of light, and to best utilize the available area of the grating 24. If desired, beam former 22 may be omitted. Alternatively, only the collimating lenses 19 may be omitted. When collimating lenses 19 and beam former 22 are omitted, a slight increase in cross-talk noise and a slight decrease in available bandwidth may result.

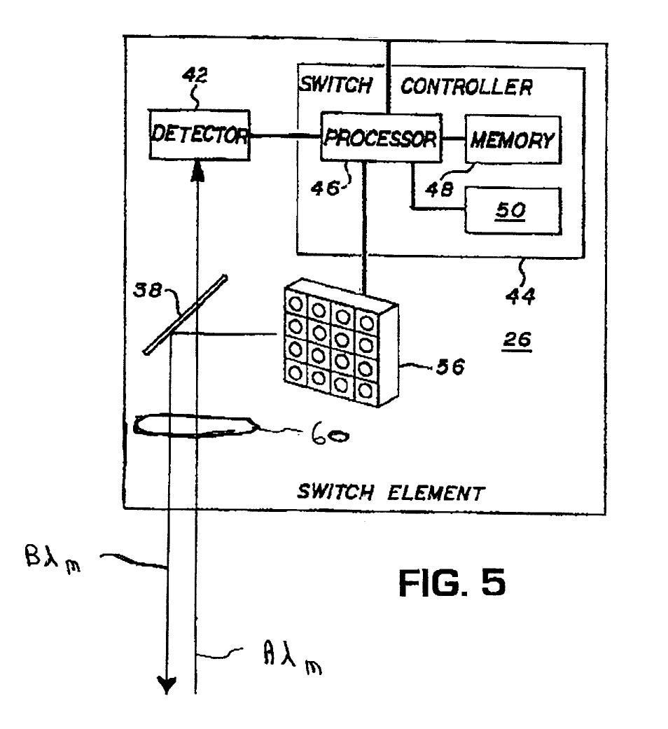

Turning to FIG. 5, each switch element 26 is arranged to receive one of the incoming sets of wavelengths Aλm. As incoming sets of wavelength Aλm enter switch element 26, it intersects lens 60 which images the wavelengths to a detector or detector array 42 and then it intersects a beam splitter 38. Each switch element may be capable of producing outgoing light signals in an outgoing set of wavelengths Bλm, which may be the same as the incoming wavelengths Aλm. Outgoing wavelengths Bλm are transmitted back along the path of the incoming wavelengths Aλm.

After passing through the beam splitter 38, wavelengths Aλm pass to detector array 42. Detector array 42 is adapted to detect signals in the range of wavelengths Aλm. Detector array 42 may generate electrical signals based on the light signals. Detector array 42 may be many different well known devices, such as 2609C Broadband Photodiode Module for both 1310 and 1550 nm detection available from Lucent Technologies or InGaAs p-i-n photodiodes for 1000-1700 nm detection, Part C30641E, available from EG&G. The electrical signals are transmitted to switch controller 44.

Switch controller 44 comprises a microprocessor 46 and memory 48. Microprocessor 46 is adapted to determine the intended destination of the optical signals and route the signal to an appropriate fiber. Microprocessor 46 may be any of a number of devices that are well known in the art. For example, microprocessor 46 may be an Intel Pentium III or other similar processor, such as a Conexant CX20462. Memory 48 is preferably random access memory that also may be any of a number of devices that are well known in the art. Switch controller 44 may also comprise non-volatile memory 50 that may contain programming instructions for microprocessor 46. Each optical signal preferably carries a header that contains information that either identifies the signal or indicates its intended destination. Switch controller 44 is adapted to read the header. Switch controller 44 may be adapted, either alone or in coordination with other devices, to determine the destination of the light signal. Switch controller 44 may be in communication with an central processor (not shown) that is adapted to provide information to the switch controller.

When switch controller 44 sends a signal, it drives emitter array 56 to generate the signal. Emitter array 56 comprises a plurality of different areas or emitters arranged in a two-dimensional array, each area being adapted to independently transmit a light signal. Each individual emitter may be many different kinds of emitters that are suitable for the particular optical fiber system. For example, an individual emitter in the 1310 nm range may be a Daytona laser, model 1861A, available from Lucent Technologies. Emitter array 56 is adapted to generate light in the outgoing set of Bλm wavelengths that beam splitter 38 is adapted to reflect. Array 56 is also adapted to generate signals in specific areas of the array so that the signal can be mapped on to the appropriate optical fiber or target. As the signal is generated, it is reflected by beam splitter 38 back along the path of the incoming signal. The outgoing signal passes back through lens 60 and is then transmitted back along the path of the incoming signal. In this manner, the signal produced by a portion of emitter array 56 is then received by at least one target 12, which in the embodiment shown in FIGS. 1-4 is fiber end 16.

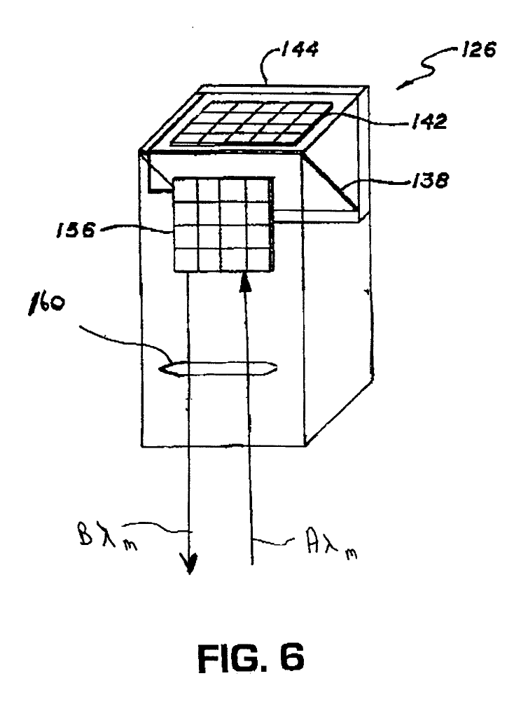

Turning to FIG. 6, each switch element 126 is arranged to receive an incoming signal. As the incoming signal enters switch element 126, it intersects lens 160 which images the fiber array on to detector array 142. Detector array 142 is adapted to detect signals in the wavelength of the incoming signal. Detector array 142 generates electrical signals based on the detected signal. The electrical signals are transmitted to switch controller 144.

Switch controller 144 may be similar to switch controller 44 with a microprocessor and memory (not shown). The microprocessor is adapted to determine the intended destination of light signals and route the signals to an appropriate fiber.

In this embodiment, since each switch element 126 is capable of receiving light signals from each fiber 14 in a predetermined range of wavelengths, conflicts or interferences between signals can be handled within the switch element. Switch controller 144 may have its own destination registry and transmission registry and can be programmed to manage signals. Switch element 126 has an emitter array 156 to generate an outgoing set of wavelengths Bλm that are transmitted back along the path of the incoming wavelengths Aλm.

### CONCLUSION

Although the description above contains many specifications, these should not be construed as limiting the scope of the invention but as merely providing illustrations of some of presently preferred embodiments of this invention. Thus, the scope of the invention should be determined by the appended claims and their legal equivalents rather than by the examples given.

What is claimed is:

1. An optical switch device comprising:
(A) at least one source, the source being adapted to transmit an optical signal;
(B) at least one target, the target being adapted to receive the optical signal;
(C) at least a first and second switch element, each switch element comprising:
(a) a detector array positioned to receive light from the source, the detector array being adapted to detect optical signals;
(b) an emitter array positioned to transmit light to the targets, the emitter array comprising a plurality of emitters, each emitter being adapted to generate light signals, wherein light signals generated by each emitter is transmitted to at least one of the plurality of targets; and
(c) a switch controller in communication with the detector and the emitter array, the switch controller being adapted to cause the emitter array to generate signals detected by the detector array;
(D) a grating positioned to receive optical signals from the source, the grating being configured to transmit optical signals in a first range of wavelengths on a first optical path and transmit optical signals in a second range of wavelengths on a second optical path;
wherein the first switch element is positioned to receive optical signals in the first range of wavelengths and to transmit optical signals to the target, the second switch element being positioned to receive optical signals in the second range of wavelengths and to transmit optical signals to the target.

2. The optical switch device according to claim 1, further comprising a first imaging lens positioned between the grating and at least one of the switch elements.

3. The optical switch device according to claim 2, wherein different wavelengths are transmitted to different portions of the imaging plane.

4. The optical switch device according to claim 3, wherein a second imaging lens is positioned adjacent the each switch element for directing the wavelengths onto the switch element.

5. The optical switch device according to claim 1, further comprising a collimating lens positioned adjacent the source, the collimating lens being adapted to collimate the optical signal.

6. The optical switch device according to claim 5, further comprising a beam former positioned between the collimating lens and the grating, the beam former being adapted to shape the optical signal.

7. The optical switch device according to claim 1, wherein the grating is a Bragg grating.

8. The optical switch device according to claim 1, wherein the grating is a reflective grating.

9. The optical switch device according to claim 1, wherein the sources and targets are an optical transmission medium.

10. The optical switch device according to claim 1, further comprising a central processor, the central processor being in communication with the switch controller, the central processor providing information to the switch controller.

11. The optical switch device according to claim 3, further comprising at least one mirror, the mirror being positioned to reflect the signal to at least one switch element.

12. An optical switch device comprising:
(A) a grating positioned to receive a optical signals, the grating being adapted to transmit optical signals in a first range of wavelengths on a first optical path and transmit optical signals in a second range of wavelengths on a second optical path;
(B) a first switch element, the first switch element being positioned in the first optical path, the first switch element comprising:
(a) a detector array positioned to receive optical signals transmitted by the grating and being adapted to detect optical signals in the first range of wavelengths;
(b) an emitter array adapted to transmit optical signals; and
(c) a switch controller in communication with the detector array and the emitter array, the switch controller being adapted to cause the emitter array to transmit optical signals; and
(C) a second switch element, the second switch element being positioned in the second optical path, the second switch element comprising:
(a) a detector array positioned to receive optical signals transmitted by the grating and being adapted to detect optical signals in the second range of wavelengths;
(b) an emitter array adapted to transmit optical signals; and
(c) a switch controller in communication with the detector array and the emitter array, the switch controller being adapted to cause the emitter array to transmit optical signals.

13. The optical switch device according to claim 12, further comprising a first imaging lens positioned between the grating and at least one of the switch elements.

14. The optical switch device according to claim 13, further comprising a second imaging lens positioned between the grating and at least one of the switch elements.

15. The optical switch device according to claim 12, further comprising a collimating lens adapted to collimate optical signals.

16. The optical switch device according to claim 12, wherein the collimating lens is positioned between a source of optical signals and the grating.

17. The optical switch device according to claim 12, further comprising a beam former adapted to shape optical signals.

18. The optical switch device according to claim 12, wherein the grating is a Bragg grating.

19. The optical switch device according to claim 12, wherein the grating is a reflective grating.

20. The optical switch device according to claim 12, further comprising at least one mirror, the mirror being positioned to reflect optical signals to at least one of the first and second switch elements.

21. A method of switching optical signals, comprising:
(A) providing at least a first and second switch element, each switch element comprising:
(a) a detector array positioned to receive a first optical signal;
(b) an emitter array positioned to transmit a second optical signal, the emitter array comprising a plurality of emitters; and
(c) a switch controller in communication with the detector and the emitter array, the switch controller adapted to cause the emitter array to generate the second optical signal;
(B) providing a grating positioned between a source and the first and second switch elements;
(C) dispersing a first optical signal into at least a first and second set of wavelengths through the grating;
(D) directing the first set of wavelengths to be incident upon the first switch element;
(E) directing the second set of wavelengths to be incident upon the second switch element.

22. The method of switching optical signals according to claim 21, further comprising:
(A) detecting the first set of wavelengths;
(B) detecting the second set of wavelengths;
(C) determining which emitter to transmit the second optical signal to; and
(D) transmitting the second optical signal from the emitter toward the grating.

23. The method of switching optical signals according to claim 22, wherein a first imaging lens is positioned adjacent the grating for directing the wavelengths onto an optical plane.

24. The method of switching optical signals according to claim 23, wherein the wavelengths form an arc on the optical plane.

25. The method of switching optical signals according to claim 24, providing a second imaging lens positioned adjacent each switch element.

26. The method of switching optical signals according to claim 25, further comprising collimating the optical signal.

27. The method of switching optical signals according to claim 21, further comprising providing a beam former positioned between the collimating lens and the grating.

28. The method of switching optical signals according to claim 21, wherein the grating is a Bragg grating.

29. The method of switching optical signals according to claim 21, wherein the grating is a reflective grating.

30. The method of switching optical signals according to claim 21, reflecting an optical signal transmitted by the grating to at least one of the first or second switch elements.
